(19) United States
(12) Patent Application Publication
(10) Pub. No.: US 2007/0134079 A1
(43) Pub. Date: Jun. 14, 2007

(54) CABINET INCLUDING A COMPONENT REPLACEMENT SYSTEM

(75) Inventors: Roy Rader, Ramsey, MN (US); Steve Esslinger, Oak Grove, MN (US)

Correspondence Address: MICHAEL BEST & FRIEDRICH, LLP, 100 E WISCONSIN AVENUE, Suite 3300, MILWAUKEE, WI, 53202, US

(73) Assignee: ZERO ZONE, INC., North Prairie, WI (US)

(21) Appl. No.: 11/609,119

(22) Filed: Dec. 11, 2006

Related U.S. Application Data
(60) Provisional application No. 60/749,661, filed on Dec. 12, 2005.

(51) Int. Cl. B65G 65/00; B65G 1/00

(52) U.S. Cl. 414/325; 414/304

(57) ABSTRACT

A cabinet includes a wall and a top coupled to the wall. The wall and the top cooperate to at least partially enclose a space. A removable component is disposed at least partially within the space and a bean is removably coupled to the top such that a portion of the beam is positioned outside of the space and the remainder of the beam is disposed within the space. An interconnecting member is connected to the beam and is removably connected to the removable component to move the removable component into and out of the space.

### CROSS REFERENCE TO RELATED APPLICATIONS

This application claims priority under 35 U.S.C. sec. 119 to provisional patent application No. 60/749,661, filed on Dec. 12, 2005, which is hereby fully incorporated by reference.

### BACKGROUND

The invention relates to a cabinet that includes a component replacement system. More particularly, the invention relates to a cabinet that includes a component replacement system that allows for removal of a component, such as a compressor, from within a cabinet.

Compressor systems often include a compressor positioned within a cabinet or housing. In many constructions, the compressor is surrounded by other components and the cabinet is positioned such that access to the compressor, and other components, is significantly restricted. For example, the cabinet may be positioned in a corner such that only one or two walls are accessible. In such a position, replacement of the compressor can be difficult.

### SUMMARY

In one embodiment, the invention provides a cabinet that includes a wall and a top Coupled to the wall. The wall and the top cooperate to at least partially enclose a space. A removable component is disposed at least partially within the space and a beam is removably coupled to the top Such that a portion of the beam is positioned outside of the space and the reminder of the beam is disposed within the space. An interconnecting member is connected to the beans and is removably connected to the removable component to move the removable component into and out of the space.

In another construction, the invention provides a cabinet that includes a base, a wall extending from the base, and a top disposed above the base and coupled to the wall. The base, the wall, and the top cooperate to at least partially enclose a space. A removable component is removably coupled to the base and is disposed at least partially within the space. A beam support is coupled to the top and a beam is removably coupled to the beam support such that a portion of the beam is positioned outside of the space and the remainder of the beam is disposed within the space. An interconnecting member is connected to the beam and is removably connected to the removable component to move the removable component into and out of the space.

In yet another construction, the invention provides a cabinet that includes a base, a wall extending from the base, and a top disposed above the base and coupled to the wall. The base, the wall, and the top cooperate to at least partially enclose a space. A condenser is coupled to the base and is disposed within the space. A compressor support is positioned such that the condenser is disposed between the compressor support and the base. A compressor is removably coupled to the compressor support and disposed at least partially within the space. A first beam support is coupled to the top and a second beam support is coupled to the top. A beam is removably coupled to the first beam support and the second beam support such that a portion of the beam is positioned outside of the space and the remainder of the beam is disposed within the space. An interconnecting member is connected to the beam and is removably connectable to the compressor to move the compressor into and out of the space.

### BRIEF DESCRIPTION OF THE DRAWING

The detailed description particularly refers to the accompanying figures in which:

FIG. 1 is a partially broken away side view of a compressor cabinet and a component replacement system attached to a compressor;

FIG. 2 is a partially broken away side view of the compressor cabinet and the component replacement system of FIG. 1 with the compressor removed;

FIG. 3 is a perspective view of a portion of the component replacement system of FIG. 1;

FIG. 4 is an end view of a portion of the component replacement system of FIG. 1; and

FIG. 5 is a perspective view of a trolley of the component replacement system of FIG. 1.

### DETAILED DESCRIPTION

Before any embodiments of the invention are explained in detail, it is to be understood that the invention is not limited in its application to the details of construction and the arrangement of components set forth in the following description or illustrated in the following figures. The invention is capable of other embodiments and of being practiced or of being carried out in various ways. Also, it is to be understood that the phraseology and terminology used herein is for the purpose of description and should not be regarded as limiting. The use of “including” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

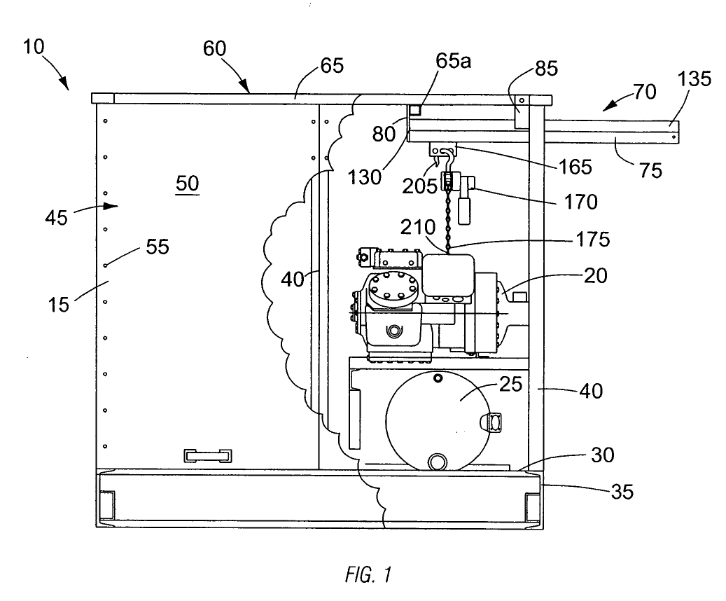

FIG. 1 illustrates a portion of a refrigeration system 10 that may be employed in any large refrigeration application. The illustrated portion includes a cabinet 15 that houses a compressor 20 and a condenser 25. The condenser 25 is positioned on a lower level 30 with the compressor 20 disposed immediately above. While not illustrated, tubes or pipes interconnect the condenser 25 and the compressor 20 as well as other components disposed within the cabinet 15 or positioned outside of the cabinet 15. Many of these components may interfere with the removal of the compressor 20. As such, generally, the compressor 20 must be lifted upward before being removed from the cabinet 15. The weight of the compressor 20, difficult access to the cabinet 15, height of the compressor 20, and interference of other components makes the task of replacing the compressor 20 difficult.

The cabinet 15 includes several lower beam members 35 that extend around the lower portion of the cabinet 15 and at least partially define the lower level 30 or base on which the condenser 25 rests. In the illustrated construction, channel shaped beams are employed with other shapes (e.g., angle, box, I-beam, T-beam, and the like) also being suitable for use. Several side beams 40 extend upward from the lower beams 35 to at least partially define side walls 45. Panels 50 attach to the side beams 40 to complete the side walls 45. While many beam shapes are well-suited to supporting the panels 50, channel or I-beams are preferred. In the illustrated construction fasteners 55 extend through the panels 50 and attach the panels 50 to the beams 40. Of course, other constructions may include other attachment systems (e.g., welding, rivets, pins, etc.) For example, one construction positions an upward opening hook member on the beams 40 and a, downward opening hook on the panels 50. The two hooks engage one another such that the panels 50 hang on the beams 40.

A cabinet top 60 includes top beams 65 that extend around the top 60 to provide the necessary structural support for the cabinet 15. In preferred constructions, the top beams 65 extend around the perimeter of the top 60 and also extend across the top 60 from the approximate midpoint of each side wall 45 to the approximate midpoint of the opposite side wall 45. Panels 50 may be positioned on top of the top beams 65 to completely enclose the cabinet 15 and the components disposed within the cabinet 15. Thus, the cabinet top 60, side walls 45, and the lower level 30 enclose a space.

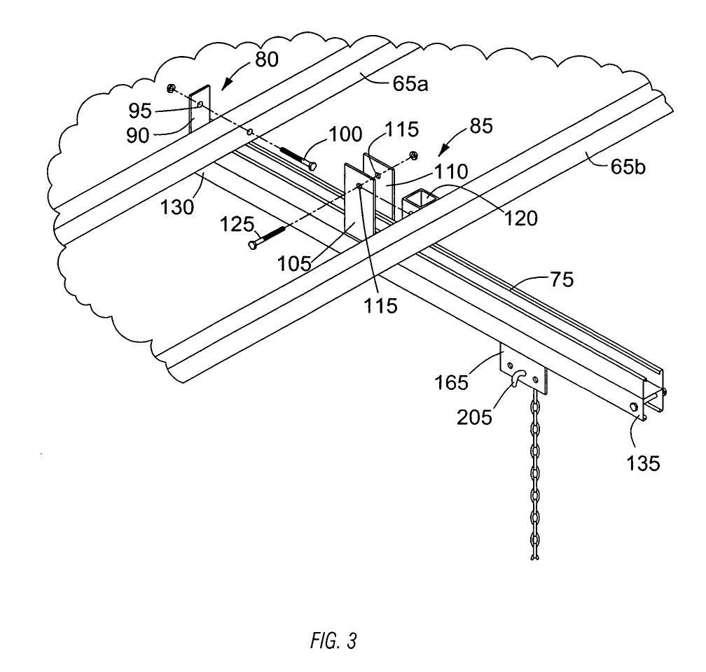

As illustrated in FIG. 3, a component replacement system 70 includes a beam or rail 75 attached to the cabinet 15 using a first attachment bracket 80 and a second attachment bracket 85. The first attachment bracket 80 includes a flat plate 90 having an aperture 95 that extends through the plate 90. The plate 90 aligns with one of the top beams 65a such that a fastener 100 can extend through the beam 65a and the plate 90 to couple the plate 90 to the beam 65a, thereby defining a first rail attachment point. In other constructions, more than one fastener 100 and/or more than one plate 90 is employed. In the illustrated construction, the top beam 65a extends in a direction that is substantially normal to the rail 75 and the first attachment bracket 80 connects directly to the beam 65a. Of course other constructions could attach to a top beam that extends in a direction that is substantially parallel to the rail 75 or could connect to the top beam 65a via all intermediate part or extension. While a fastener 100 has been illustrated and described, other attachment means could be employed. For example, a U-bolt could extend under the rail 75 and around the beam 65a to facilitate attachment of the rail 75 to the cabinet 15.

The second attachment bracket 85 includes a first side plate 105 and a second side plate 110 that include aligned apertures 115 that extend through each plate 105, 110. The plates 105. 110 align with an extension 120 that is attached (e.g., welded) to another top beam 65b such that a fastener 125 can pass through each of the plates 105, 110 and the extension 120 to attach the plates 105, 110 to the beam 65b, thereby defining a second rail attachment point. As with the first attachment bracket 80, other attachment brackets, methods, or systems could be used in place of the two plates 105, 110 illustrated in FIG. 3. In addition, the first attachment bracket 80 could be used in place of the second attachment bracket 85 or the second attachment bracket 85 could be used in place of the first attachment bracket 80 as desired.

With continued reference to FIG. 3, the first attachment bracket 80 is permanently attached adjacent a first end 130 of the rail 75 and the second attachment bracket 85 is permanently attached to the rail 75 between the first end 130 and a second end 135 of the rail 75. This arrangement of the brackets 80, 85 allows the rail 75 to be completely supported at two points and extend in a cantilever fashion beyond the two top beams 65a, 65b to which the rail 75 is attached and outside of the cabinet 15. In preferred constructions, the attachment brackets 80, 85 are welded to the rail 75. Of course other constructions may use fasteners, such as bolts or rivets, or other attachment methods to attach the brackets 80, 85 to the rail 75.

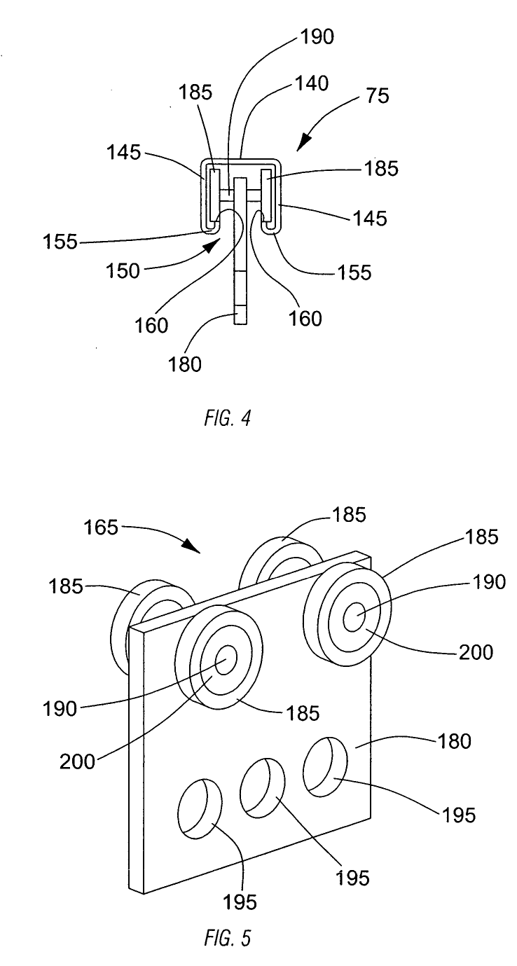

FIGS. 3 and 4 illustrate one possible construction of the rail 75 that is suitable for use with the present invention. The rail is generally U-shaped and includes a top portion 140 and two side portions 145 that cooperate to partially enclose a channel or a rail space 150. Each of the side portions 145 includes an edge 155 that is bent inward such that it extends toward the top portion 140. Each of the two edges 155 defines a bearing surface 160 that is disposed within the rail space 150. As one or ordinary skill will realize, different shaped rails 75 are also suitable for use with the present invention. For example, in another construction, an I-shaped rail is used in place of the U-shaped rail 75. In the I-shaped rail construction, the upper surfaces of the lower let of the I-shaped rail define bearing surfaces.

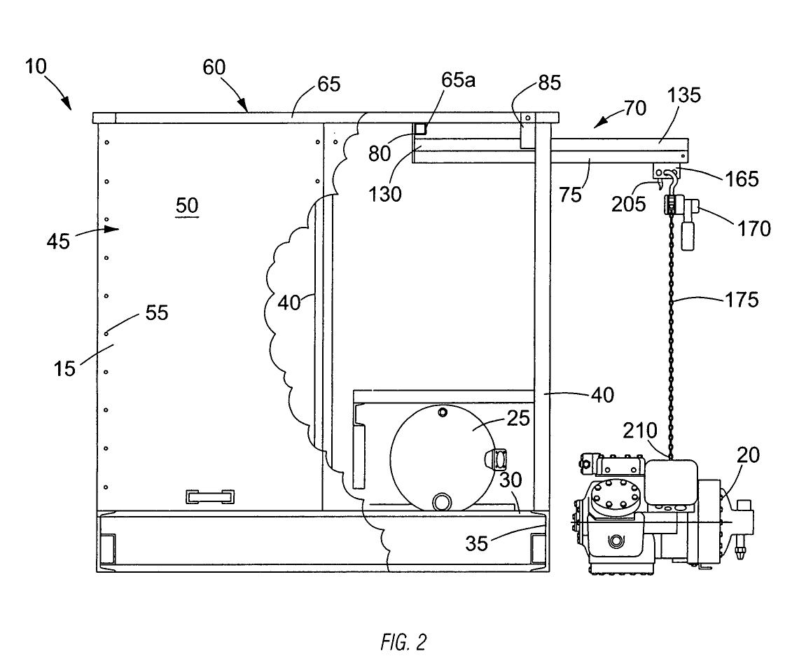

As illustrated in FIGS. 1 and 2, the component replacement system 70 also includes an interconnecting member that includes a trolley 165, a hoist mechanism 170, and rigging 175 such as a chain or a hook. The trolley 165, illustrated in FIG. 5, includes a plate 180, four rollers or wheels 185, and two shafts 190 that couple the wheels 185 to the plate 180. The plate 180 includes at least one lower aperture 195 that provides a connection point between the trolley 165 and the rigging 175. In the illustrated construction, three lower apertures 195 are provided.

Each of the shafts 190 extends through an aperture in the plate 180 such that the shafts are disposed above the lower apertures 195. In the illustrated construction, the shafts 190 arc fixedly attached (e.g., welded) to the plate 180 and do not rotate. Or course other constructions may position a bearing in the apertures such that the shaft 190 is able to rotate if desired. Each wheel 185 includes a bearing 200 that engages the shaft 190 and allows the wheel 185 to rotate about the shaft 190 to which it is attached. Each wheel 185 is also independent of the other wheels 185, thereby allowing independent rotation of the various wheels 185 as may be necessary.

The shafts 190 and wheels 185 are sized to fit within the rail space 150 such that the wheels 185 are positioned in rolling contact with the bearing surfaces 160. In this position, the trolley 165 is able to roll along the length of the rail 75 and is inhibited from moving out of rolling contact with the rail 75. As illustrated in FIG. 3, a channel stop in the form of an end bolt 203 is positioned at the second end 135 of the rail 75 to act as a stop and inhibit the trolley 165 from rolling out of the rail 75. The first attachment bracket 80 is positioned over the opening on the first end 130 and also functions to inhibit the trolley 165 from rolling out of the rail 75.

The trolley arrangement is closely related to the rail arrangement. As such, in constructions that employ different shaped rails, different shaped trolleys are likely required. For example, a trolley that engages an I-shaped rail must be different from the illustrated trolley 165. As such, the trolley arrangement should not be limited to the examples described herein.

The hoist 170 attaches to the trolley 165 to facilitate easy movement of the hoist 170 along the length of the rail 75. In preferred constructions, an electrically powered hoist 170 is employed. However, other constructions may include a manually operated hoist 170. In the illustrated construction, the hoist 170 includes a hook 205 that engages the trolley 165 to attach the hoist 170 to the rail 75. The rigging 175 extends downward from the hoist 170 and includes all end member 210 that can be attached to the compressor 20 or other equipment to be removed. Actuation of the hoist 170 moves the end member 210 up toward the rail 75 or downward away from the rail 75 as desired.

In preferred constructions, the rail 75, trolley 165 and hoist 170 are stored in the cabinet 15 or elsewhere in a non-operating position. To use the component replacement system 70, the rail 75 is removed from the storage position and is attached to the top beams 65a, 65b of the cabinet 15. As discussed, two fasteners 100, 125 can be used to fully attach the rail 75 to the top beams 65a, 65b. Once attached, the trolley 165 is inserted into the rail space 150 through the second end 135 of the rail 75 and the end bolt 203 is positioned to lock the trolley 165 within the rail space 150. The hoist 170 is then attached to the trolley 165 to allow the hoist 170 to be moved into the desired position.

In use, the hoist 170 is positioned over the removable component such as the compressor 20 or other component to be removed and the rigging 175 is lowered to connect to the compressor 20. The compressor 20 is disconnected from the cabinet 15 and from any other components (e.g., sensors, tubing, pipes, etc.) that may be connected to the compressor 20. The hoist 170 is then actuated to lift the compressor 20 upward to clear any other components or obstructions that may also be housed within the cabinet 15. The trolley 165 is then rolled to the second end 135 of the rail 75 such that the compressor 20 is outside of the cabinet 15. The hoist 170 is again actuated to set the compressor 20 on the floor or onto a handcart or other transportation device. The process just described is then reversed to install a replacement or repaired compressor 20 in the cabinet 15.

While the preceding description and illustrations discuss the use of the component replacement system 70 in conjunction with the replacement of a compressor 20, one of ordinary skill in the art will realize that the component replacement system 70 could be applied to many other components or systems that are commonly enclosed within a cabinet 15. For example, large oil pumps, small turbines or engines, generators, heat exchangers, and the like are often enclosed within cabinets 15 and the present invention could be applied to these cabinets 15 to replace any or all of these components. As such, the invention should not be limited to compressor replacement systems alone.

Thus, the invention provides, among other things, a new and useful system and method for replacing a heavy component disposed within a cabinet 15. The constructions of the component replacement system 70 described above and illustrated in the figures are presented by way of example only and are not intended as a limitation upon the concepts and principles of the invention.

What is claimed is:

1. A cabinet comprising:
a wall;
a top coupled to the wall, the wall and the top cooperating to at least partially enclose a space:
a removable component disposed at least partially within the space;
a beam removably coupled to the top such that a portion of the beam is positioned outside of the space and the remainder of the beam is disposed within the space; and
an interconnecting member connected to the beam and removably connected to the removable component to move the removable component into and out of the space.

2. A The cabinet of claim 1, further comprising a base, and wherein the wall, the top, and the base cooperate to completely enclose the space.

3. The cabinet of claim 1, wherein the top includes a first beam attachment point and a second beam attachment point.

4. The cabinet of claim 1, wherein the beam includes a channel adapted to movably receive the interconnecting member.

5. The cabinet of claim 4, wherein the interconnecting member includes a trolley that rollably engages the channel.

6. The cabinet of claim 5, wherein the beam includes a channel stop positioned to inhibit movement of the trolley beyond the channel stop.

7. The cabinet of claim 4, wherein the trolley includes a first pair of rollers that define a roller width, the roller width sized to fit within the channel.

8. The cabinet of claim 7, wherein the trolley includes a second pair of rollers spaced apart a distance substantially equal to the roller width such that the second pair of rollers fit within the channel.

9. The cabinet of claim 1, wherein the interconnecting member includes a trolley, a hoist, and rigging that interconnects the trolley, the hoist and the removable component.

10. A cabinet comprising:
a base;
a wall extending from the base;
a top disposed above the base and coupled to the wall, the base, the wall, and the top cooperating to at least partially enclose a space;
a removable component removably coupled to the base and disposed at least partially within the space;
a beam support coupled to the top;
a beam removably coupled to the beam support such that a portion of the beam is positioned outside of the space and the remainder of the beam is disposed within the space; and
an interconnecting member connected to the beam and removably connected to the removable component to move the removable component into and out of the space.

11. The cabinet of claim 10, wherein the wall, the top, and the base cooperate to completely enclose the space.

12. The cabinet of claim 10, further comprising a second beam support coupled to the top, the beam support and the second beam support adapted to completely support the beam.

13. The cabinet of claim 10, wherein the beam includes a channel adapted to movably receive the interconnecting member.

14. The cabinet of claim 13, wherein the interconnecting member includes a trolley that rollably engages the channel.

15. The cabinet of claim 14, wherein the beam includes a channel stop positioned to inhibit movement of the trolley beyond the channel stop.

16. The cabinet of claim 13, wherein the trolley includes a first pair of rollers that define a roller width, the roller width sized to fit within the channel.

17. The cabinet of claim 16, wherein the trolley includes a second pair of rollers spaced apart a distance substantially equal to the roller width such that the second pair of rollers fit within the channel.

18. The cabinet of claim 10, wherein the interconnecting member includes a trolley, a hoist, and rigging that interconnects the trolley, the hoist and the removable component.

19. A cabinet comprising:
a base;
a wall extending from the base;
a top disposed above the base and coupled to the wall, the base, the wall, and the top cooperating to at least partially enclose a space;
a condenser coupled to the base and disposed within the space;
a compressor support positioned such that the condenser is disposed between the compressor support and the base;
a compressor removably coupled to the compressor support and disposed at least partially within the space.
a first beam support coupled to the top;
a second beam support coupled to the top;
a beam removably coupled to the first beam support and the second beam support such that a portion of the beam is positioned outside of the space and the remainder of the beam is disposed within the space; and
all Interconnecting member connected to the beam and removably connectable to the compressor to move the compressor into and out of the space.

20. The cabinet of claim 19, wherein the first beam support and the second beam support completely support the beam.

21. The cabinet of claim 19, wherein the beam includes a channel adapted to movably receive the interconnecting member.

22. The cabinet of claim 22, wherein the interconnecting member includes a trolley that rollably engages the channel.

23. The cabinet of claim 23, wherein the beam includes a channel stop positioned to inhibit movement of the trolley beyond the channel stop.

24. The cabinet of claim 22, wherein the trolley includes a first pair of rollers that define a roller width, the roller width sized to fit within the channel.

25. The cabinet of claim 25, wherein the trolley includes a second pair of rollers spaced apart a distance substantially equal to the roller width such that the second pair of rollers fit within the channel.

26. The cabinet of claim 19, wherein the interconnecting member includes a trolley, a hoist, and rigging that interconnects the trolley, the hoist and the compressor.
